(19) United States
(12) Patent Application Publication
(10) Pub. No.: US 2020/0353471 A1
(43) Pub. Date: Nov. 12, 2020

(54) CARTRIDGE AND FLUID HANDLING SYSTEM INCLUDING SAME

(71) Applicant: Enplas Corporation, Saitama (JP)

(72) Inventors: Takumi YAMAUCHI, Saitama (JP); Ken KITAMOTO, Saitama (JP)

(73) Assignee: Enplas Corporation, Saitama (JP)

(21) Appl. No.: 16/966,049

(22) PCT Filed: Jan. 23, 2019
(86) PCT No.: PCT/JP2019/002023

§ 371 Date: Jul. 30, 2020

(30) Foreign Application Priority Data
Jan. 31, 2018 (JP) 2018-014839

(51) Int. Cl. B01L 3/00

(52) U.S. Cl. CPC B01L 3/523; B01L 3/502; B01L 2300/0832; B01L 2200/0605; B01L 2300/042; B01L 2200/026

(57) ABSTRACT

This cartridge includes: a reservoir that includes an accommodation part and an opening part; and a cap fitted to the opening part. The opening part of the reservoir has: a pressing region and an open region. The cap has a first region that is pressed when the cap is positioned in the pressing region. When the first region is positioned in the pressing region and a through hole in the first region is closed, the cartridge is in a closed state in which the fluid inside the container part is not discharged to the outside via the through hole, and when, from the closed state, the first region moves into the open region and the through hole in the first region opens, the cartridge is in an open state in which the fluid can be discharged from the accommodation part to the outside via the through hole.

### TECHNICAL FIELD

The present invention relates to a cartridge, and a fluid handling system including the same.

### BACKGROUND ART

In the related art, when testing and analyzing various fluids, it is common to take the necessary amount of sample from the housing for storing the fluid (sample) by pipette or the like and inject it into the chip or device for analysis. In the related art, a device capable of automatically taking a sample by a pipette and injecting the sample into a chip is proposed (e.g., PTL 1 and PTL 2).

### CITATION LIST

### Patent Literature

### PTL 1

Japanese Patent Application Laid-Open No. 2013-150634

### PTL 2

WO2013/088913

### SUMMARY OF INVENTION

### Technical Problem

However, in the analysis devices described in PTLs 1 and 2, a means for suctioning the sample into the pipette and a means for moving the pipette are required. In addition, a plurality of pipettes is required to inject multiple samples or reagents into the chip, and moreover, a plurality of pipettes has to be controlled. As a result, the device tends to be large and the cost tends to be increased.

To solve such problems, an object of the present invention is to provide a cartridge and a fluid handling system including the cartridge that can inject fluid into a desired chip and the like without using a large device.

### Solution to Problem

The present invention provides the following cartridge.

A cartridge includes a reservoir including a housing part configured to house fluid and an opening disposed in a portion of the housing part and configured to communicate between the housing part and outside; and a cap configured to be fitted to the opening of the reservoir and composed of an elastomer having flexibility, the cap having a columnar shape and including a through hole that is substantially parallel to a central axis of the cap. The opening of the reservoir includes a pressing region configured to press a portion of the cap toward the central axis, and an open region whose pressing force toward the central axis of the cap is smaller than that of the pressing region. The cap includes a first region configured to be pressed toward the central axis when located in the pressing region of the reservoir. When the first region is located in the pressing region and an exterior wall of the opening presses the first region toward the central axis such that the through hole of the first region is closed, a closed state in which fluid in the housing part is not discharged to the outside through the through hole is set. When the first region is moved to the open region and the through hole of the first region is opened, an open state in which the fluid is allowed to be discharged to the outside from the housing part through the through hole is set.

The present invention also provides the following fluid handling system.

A fluid handling system includes the cartridge; and a channel chip including an inlet to which a second end portion of the cap is inserted, the second end portion being located on a side opposite to the first end portion facing the housing part. When the first region of the cap of the cartridge is moved from a pressing region side into the open region of the reservoir, the fluid is discharged from the housing part toward the channel chip through the through hole of the cap.

### Advantageous Effects of Invention

According to the present invention, it is possible to achieve a cartridge capable of injecting fluid into a channel chip and the like by a simple way without providing a means for driving a pipette and/or a means for conveying a chip.

### BRIEF DESCRIPTION OF DRAWINGS

FIG. 1 is an exploded perspective view of a cartridge according to an embodiment of the present invention;

FIG. 2A is a front view of a reservoir of the cartridge according to the embodiment of the present invention, FIG. 2B is a plan view of the reservoir, FIG. 2C is a bottom view of the reservoir, and FIG. 2D is a side view of the reservoir;

FIG. 3A is a sectional view of the reservoir illustrated in FIG. 2C taken along line A-A, FIG. 3B is a sectional view of the reservoir illustrated in FIG. 2C taken along line B-B, FIG. 3C is a partially enlarged view of the reservoir illustrated in FIG. 2C in a region surrounded by a broken line, FIG. 3D is a partially enlarged view of the reservoir illustrated in FIG. 2B in a region surrounded by a broken line;

FIG. 4A is a perspective view of a cap of the cartridge according to the embodiment of the present invention as viewed from the top surface side, FIG. 4B is a perspective view of the cap as viewed from a bottom surface side, FIG. 4C is a front view of the cap, FIG. 4D is a plan view of the cap, FIG. 4E is a sectional view of the cap illustrated in FIG. 4D taken along line A-A, FIG. 4F is a sectional view of the cap illustrated in FIG. 4D taken along line B-B;

FIG. 5 is an exploded perspective view of a fluid handling system according to a first embodiment of the present invention;

FIG. 6 is a bottom view of a main body part of a channel chip of the fluid handling system of FIG. 5;

FIG. 7A is a sectional view of the fluid handling system illustrated in FIG. 5 taken along line A-A in the state where the cartridge is set to a closed state, and FIG. 7B is a sectional view of the fluid handling system illustrated in FIG. 5 taken along line B-B in the state where the cartridge is set to a closed state;

FIG. 8A is a sectional view of the fluid handling system illustrated in FIG. 5 taken along line A-A in the state where the spacer is removed, and FIG. 8B is a sectional view of the fluid handling system illustrated in FIG. 5 taken along line B-B in the state where the spacer is removed;

FIG. 9A is a sectional view of the fluid handling system illustrated in FIG. 5 taken along line A-A in the state where the cartridge is set to an open state, and FIG. 9B is a sectional view of the fluid handling system illustrated in FIG. 5 taken along line B-B in the state where the cartridge is set to an open state;

FIG. 10 is an exploded perspective view of a fluid handling system according to a second embodiment of the present invention;

FIG. 11A is a perspective view of an auxiliary member of the fluid handling system of FIG. 10, FIG. 11B is a perspective view of the auxiliary member as viewed from another angle, FIG. 11C is a plan view of the auxiliary member, and FIG. 11D is a sectional view taken along line A-A of FIG. 11C;

FIG. 12A is a perspective view of a state before the cap is fitted to the auxiliary member in the fluid handling system of FIG. 10, FIG. 12B is a perspective view of a state after the cap is fitted to the auxiliary member, FIG. 12C is a plan view of a state after the cap is fitted to the auxiliary member, and FIG. 12D is a sectional view taken along line A-A of FIG. 12C;

FIG. 13 is a perspective view of a state where the cartridge of the fluid handling system of FIG. 10 is set to a closed state;

FIG. 14A is a plan view of the fluid handling system illustrated in FIG. 13, and FIG. 14B is a sectional view taken along line A-A of FIG. 14A;

FIG. 15A is a perspective view of a state where the cartridge of the fluid handling system of FIG. 10 is set to an open state, and FIG. 15B is a sectional view taken along line A-A of FIG. 15A;

FIG. 16 is an exploded perspective view of a fluid handling system according to a third embodiment of the present invention;

FIG. 17 is a bottom view of a main body part of a channel chip of the fluid handling system of FIG. 16; and

FIG. 18A is a perspective view of a side on which a supporting part is formed in a main body part of a channel chip of the fluid handling system of FIG. 16, FIG. 18B is a plan view of the main body part of the channel chip, and FIG. 18C is a sectional view taken along line A-A of FIG. 18B.

### DESCRIPTION OF EMBODIMENTS

### 1. Cartridge

A cartridge according to an embodiment of the present invention is elaborated below with reference to the accompanying drawings. Note that the drawings may not necessarily be drawn to scale for the sake of clarity of illustration.

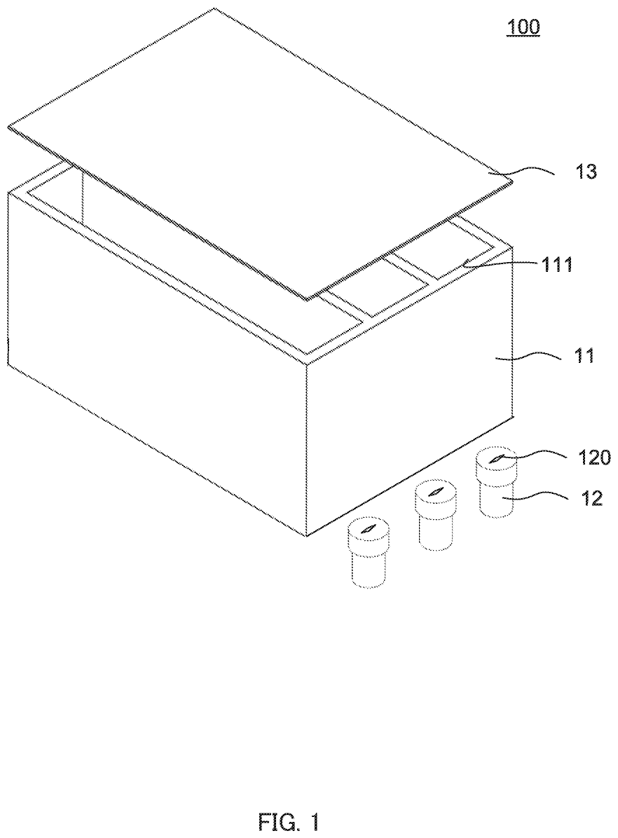

As illustrated in the exploded perspective view of FIG. 1, cartridge 100 according to the embodiment of the present invention includes reservoir 11 for housing fluid, cap 12 that is fitted to an opening (not illustrated) disposed in the bottom of reservoir 11, and lid 13 that covers reservoir 11. Note that cartridge 100 may be distributed in the state where cap 12 and lid 13 are removed from reservoir 11.

In cartridge 100 of the present embodiment, when fluid is housed in reservoir 11 (this state is hereinafter referred to also as “closed state” of cartridge 100), cap 12 serves as a stopper of the opening of reservoir 11. On the other hand, when fluid is ejected out of reservoir 11 (this state is hereinafter referred to also as “open state” of cartridge 100), through hole 120 of cap 12 serves as a channel. Each member constituting cartridge 100 is elaborated below.

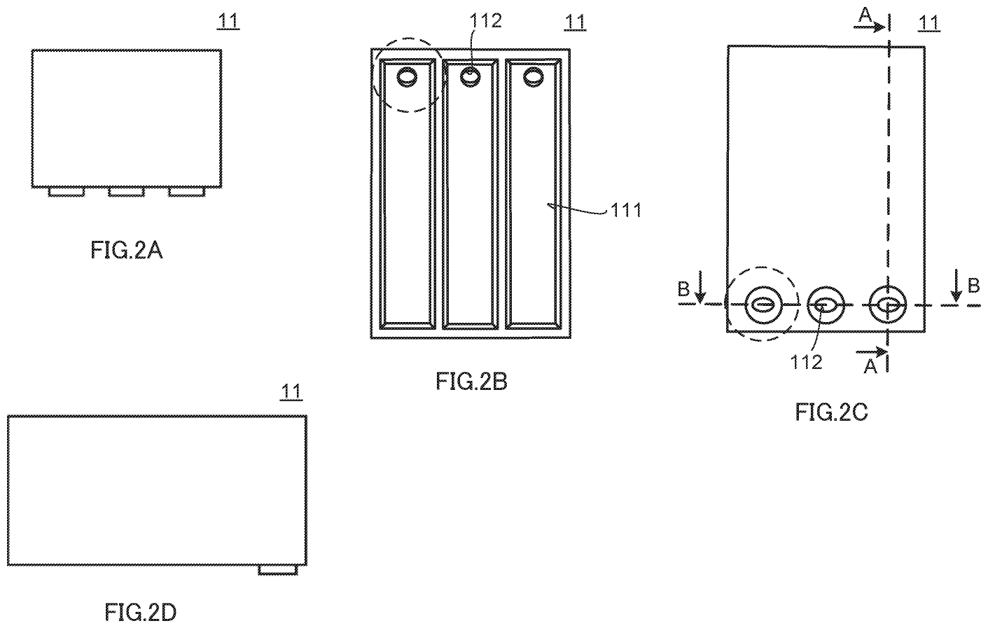

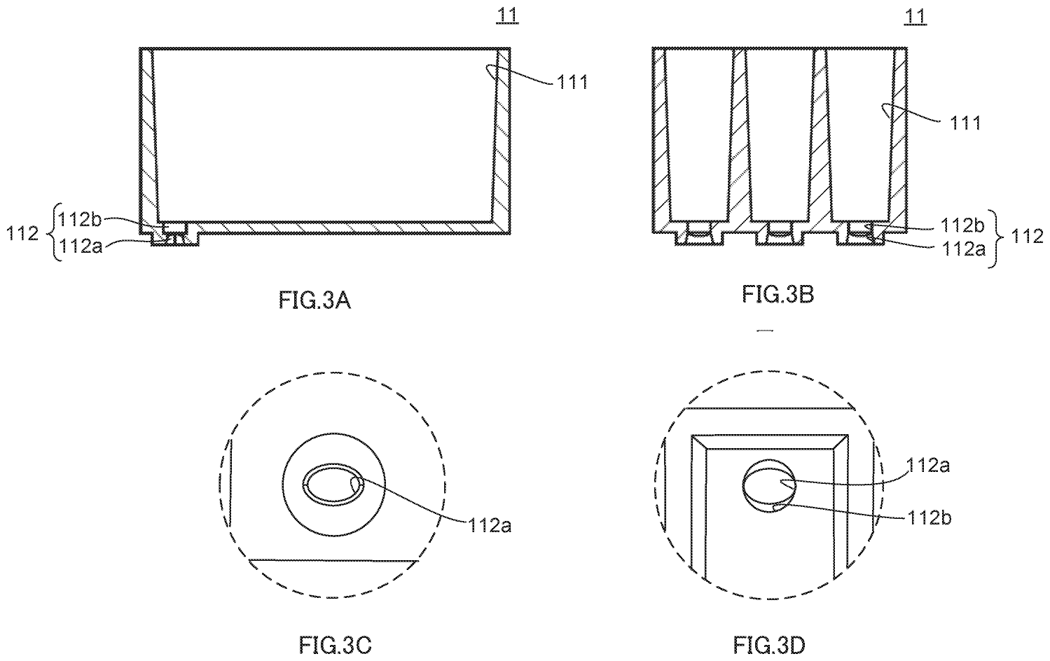

FIG. 2A is a front view of reservoir 11, FIG. 2B is a plan view of reservoir 11, FIG. 2C is a bottom view of reservoir 11, and FIG. 2D is a side view of reservoir 11. In addition, FIG. 3A is a sectional view of reservoir 11 illustrated in FIG. 2C taken along line A-A, FIG. 3B is a sectional view of reservoir 11 illustrated in FIG. 2C taken along line B-B, FIG. 3C is a partially enlarged view of a portion surrounded by a broken line in FIG. 2C, and FIG. 3D is a partially enlarged view of a portion surrounded by a broken line in FIG. 2B.

Reservoir 11 of the present embodiment includes three housing parts 111, and three openings 112 disposed in bottoms of respective housing parts 111. The shape of reservoir 11 is not limited as long as a desired amount of fluid can be housed in housing part 111, and may be a substantially cuboid shape, a columnar shape and the like, for example. Note that the numbers of openings 112 and housing parts 111 disposed in reservoir 11 are not limited, and can be appropriately selected in accordance with the application of cartridge 100. For example, a plurality of opening 112 may be disposed in one housing part 111. In addition, while three housing parts 111 have the same shape and three openings 112 have the same shape in the present embodiment, the shapes may be different from each other.

In the present embodiment, housing part 111 of reservoir 11 is a bottomed recess having a substantially cuboid shape. Note that the shape of housing part 111 is not limited as long as a desired amount of fluid can be housed, and may be a recess having a truncated pyramid shape, a columnar shape, a truncated cone shape or the like, for example. In addition, in the present embodiment, the bottom surface of housing part 111 is set to be approximately parallel to the surface of the housed fluid, but a part or all of the bottom surface may be tilted downward in the gravity direction toward the opening 112 side.

On the other hand, opening 112 is a hole for fitting cap 12 described later, and for communicating between the inside of housing part 111 and the outside of reservoir 11. In the present embodiment, opening 112 is disposed such that a portion of the exterior wall of opening 112 protrudes from the bottom surface of reservoir 11.

Here, as illustrated in FIGS. 3A to 3D, opening 112 of the present embodiment has a shape in which pressing region 112a having a substantially elliptical columnar opening and open region 112b having a substantially columnar opening are provided in series.

Pressing region 112a is a region for housing a first region of cap 12 when cartridge 100 is set to the closed state, and is a region for pressing a portion of cap 12 toward its central axis. In the present embodiment, the shape of the first region of cap 12 is a columnar shape, and the shape of the opening of pressing region 112a is a substantially elliptical columnar shape. Therefore, when the first region of cap 12 of the columnar shape is housed in pressing region 112a, the first region of cap 12 is pressed by the exterior wall of pressing region 112a toward its central axis. As a result, through hole 120 in the first region of cap 12 is closed, and the discharge of fluid through through hole 120 of cap 12 is suppressed.

Note that it suffices that pressing region 112a has a shape with which at least a portion of through hole 120 in the first region of cap 12 is closed when the first region of cap 12 is housed, and pressing region 112a may have an opening whose cross-sectional area is constant from the outside of reservoir 11 to the open region 112b side, for example. Note that, for the purpose of easily fitting cap 12, pressing region 112a of the present embodiment has a tapered opening whose cross-sectional area decreases toward the open region 112b side from the outside of reservoir 11.

On the other hand, when cartridge 100 is set to the open state, a second region of cap 12 is housed in pressing region 112a. For this reason, pressing region 112a of the present embodiment has an opening that does not close through hole 120 of the second region when the second region of cap 12 is housed.

In addition, open region 112b in opening 112 is a region for housing the first region of cap 12 when cartridge 100 is set to the open state, and is a region where the pressing force toward the central axis of cap 12 when the first region of cap 12 is housed is smaller than that of pressing region 112a. In the present embodiment, the pressure toward the central axis of cap 12 is reduced by setting open region 112b such that the cross-sectional area of the opening of open region 112b is wider than that of pressing region 112a. In addition, open region 112b of the present embodiment includes the opening that has a shape (columnar shape) similar to the external shape of the first region of cap 12. When the first region of cap 12 is housed in open region 112b of the columnar shape, the first region of cap 12 is reset to normal columnar shape due to its flexibility. As a result, through hole 120 is opened, and fluid can pass through the inside of through hole 120 of cap 12.

Note that if a gap is formed between open region 112b and the first region of cap 12, fluid may be discharged to the outside of housing part 111 through the gap. For this reason, the diameter of the columnar opening of open region 112b of the present embodiment is smaller than the diameter of the first region of cap 12 having the columnar shape.

Here, reservoir 11 including housing part 111 and opening 112 may be made of a resin material that is not eroded by the fluid housed in housing part 111. Examples of the material of reservoir 11 include polyester such as polyethylene terephthalate; polycarbonate; acrylic resin such as polymethylmethacrylate; polyvinyl chloride; polyolefin such as polyethylene, polypropylene, and cycloolefin resin; polyether; polystyrene; silicone resin; and a resin material such as various elastomers. In addition, reservoir 11 can be molded by injection molding and the like, for example.

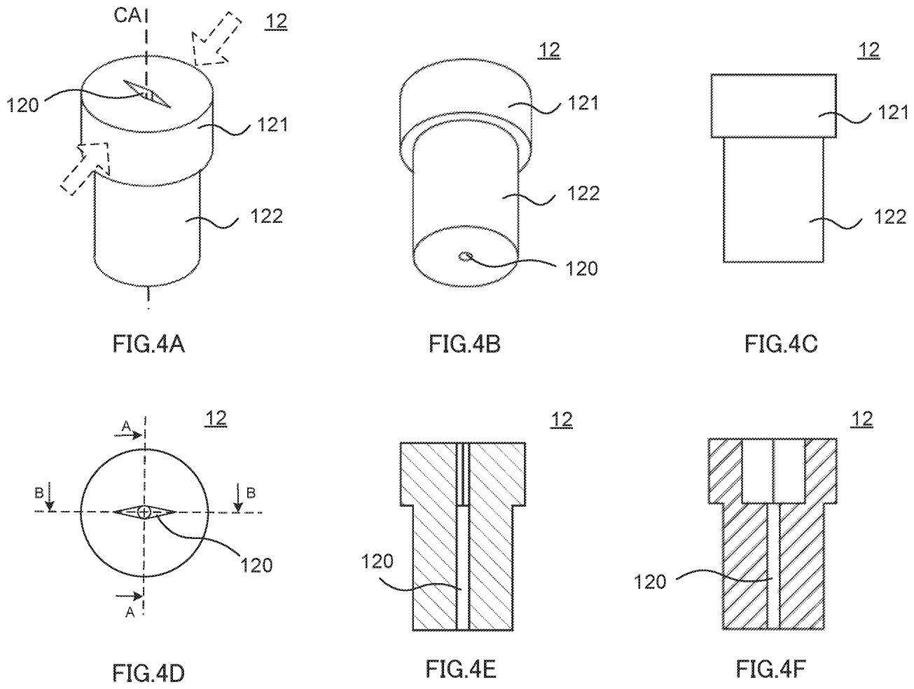

FIG. 4A is a perspective view illustrating cap 12 of the present embodiment as viewed from the top surface side, and FIG. 4B is a perspective view as viewed from the bottom surface side. FIG. 4C is a front view of the cap 12, and FIG. 4D is a plan view. Note that FIG. 4E is a sectional view taken along line A-A of cap 12 illustrated in FIG. 4D, and FIG. 4F is a sectional view taken along line B-B of cap 12 illustrated in FIG. 4D.

Cap 12 of the present embodiment is a substantially columnar member, and includes through hole 120 that is approximately parallel to central axis CA thereof. In addition, cap 12 includes first region 121 having a columnar shape that is pressed by the exterior wall of opening 112 (pressing region 112a) so as to close through hole 120 when housed in pressing region 112a of opening 112 of reservoir 11, and second region 122 having a columnar shape whose cross-sectional area in the direction perpendicular to the central axis of cap 12 is smaller than that of the first region 121. In addition, in the cap 12, the bottom of first region 121 and the top of second region 122 are connected with each other.

Here, the diameter of first region 121 having the columnar shape is appropriately set in accordance with the opening width and cross-sectional area of opening 112 of reservoir 11 (pressing region 112a and open region 112b). In addition, the shape of through hole 120 of first region 121 in the direction perpendicular to central axis CA is not limited as long as it is closed with no gap when first region 121 is housed in pressing region 112a of reservoir 11, and may be, for example, a slit shape. Note that “slit shape” as used herein is a gap elongated in one direction in the cross-section perpendicular to central axis CA of cap 12, and is a gap that is closed in a linear shape when pressed from the both sides along the minor axis direction. In the present embodiment, as illustrated in FIG. 4A, the shape of through hole 120 in the direction perpendicular to central axis CA is a rhombic shape with one diagonal sufficiently longer than the other.

Here, the width and the shape of the opening of through hole 120 of first region 121 in the direction perpendicular to central axis CA are appropriately selected in accordance with the fluid type, and the desired fluid flow rate.

In addition, the height of first region 121 is not limited, and is appropriately selected in accordance with the shape of opening 112 (pressing region 112a and open region 112b) of reservoir 11. Note that from the viewpoint of discharging the housing part 111 in which the fluid is housed without leaving any residue, it is preferable that first region 121 has a height at which the end portion of cap 12 (first region 121 side) does not protrude into housing part 111 when it is housed in open region 112b of reservoir 11. That is, it is preferable to set the height of first region 121 to a height equal to or smaller than the height of open region 112b.

On the other hand, the diameter of second region 122 having the columnar shape is appropriately set in accordance with the width and cross-sectional area of the opening of pressing region 112a of reservoir 11. In addition, the width and the shape of the opening of through hole 120 of second region 122 in the direction perpendicular to central axis CA are appropriately selected in accordance with the fluid type, and the desired fluid flow rate, and may be the same as or different from the shape of through hole 120 of first region 121. In the present embodiment, the cross-sectional shape of through hole 120 of second region 122 in the direction perpendicular to central axis CA is a circular shape.

In addition, the height of second region 122 is appropriately selected, and is set to a height at which a portion of second region 122 protrudes from opening 112 of reservoir 11 when first region 121 is housed in open region 112b of reservoir 11, for example. As described later, cartridge 100 of the present embodiment is used in the state where the end portion located on the second region side (the side opposite to housing part 111 of reservoir 11) of cap 12 is inserted in various chips, devices and the like. For this reason, the height thereof is not limited as long as the end portion can be inserted to various chips, devices and the like.

Here, it suffices that cap 12 is made of a material having flexibility, and may be made of publicly known elastomer. The elastomer resin includes thermoplastic resin and thermosetting resin, and both may be used for cap 12. Examples of the heat curable elastomer resin that can be used for cap 12 include polyurethane resins, and polysilicone resins. Examples of thermoplastic elastomeric resins include styrene resins, olefin resins, and polyester resins. Specific examples of olefin resins include polypropylene resin. In addition, first region 121 and second region 122 of cap 12 may be composed of the same material, or different materials. Note that a view point of ease of manufacture, it is preferable to use the same material. In addition, cap 12 can be molded by injection molding, for example.

In addition, lid 13 of cartridge 100 is not limited as long as it is a member that can suppress leakage of fluid from the top surface side of housing part 111 when fluid is housed in housing part 111 of reservoir 11. Lid 13 may have a structure that can be detachable from reservoir 11, or may be a film or the like that is bonded to reservoir 11. Lid 13 may be bonded to reservoir 11 with an adhesive agent (such as a hot-melt adhesive agent and a pressure sensitive adhesive agent) for example.

Lid 13 is not limited as long as it is a film made of a material that is not eroded by the fluid, and the thickness and the like of lid 13 are appropriately selected. Examples of the material of lid 13 include polyester such as polyethylene terephthalate; polycarbonate; acrylic resin such as polymethylmethacrylate; polyvinyl chloride; polyolefin such as polyethylene, polypropylene, and cycloolefin resin; polyether; polystyrene; silicone resin; resin materials such as various elastomers, and metals such as aluminum.

Lid 13 may partially include an opening, and a cap made of the elastomer described above may be disposed at the opening. The shape of the opening of lid 13 may be the same as the shape of the opening of reservoir 11, for example. The opening provided in lid 13 that can be opened and closed by the cap may be utilized as an air hole, an introduction part used for supplying reagent into the reservoir, and the like.

### 2. Fluid Handling System

### 2-1. First Embodiment

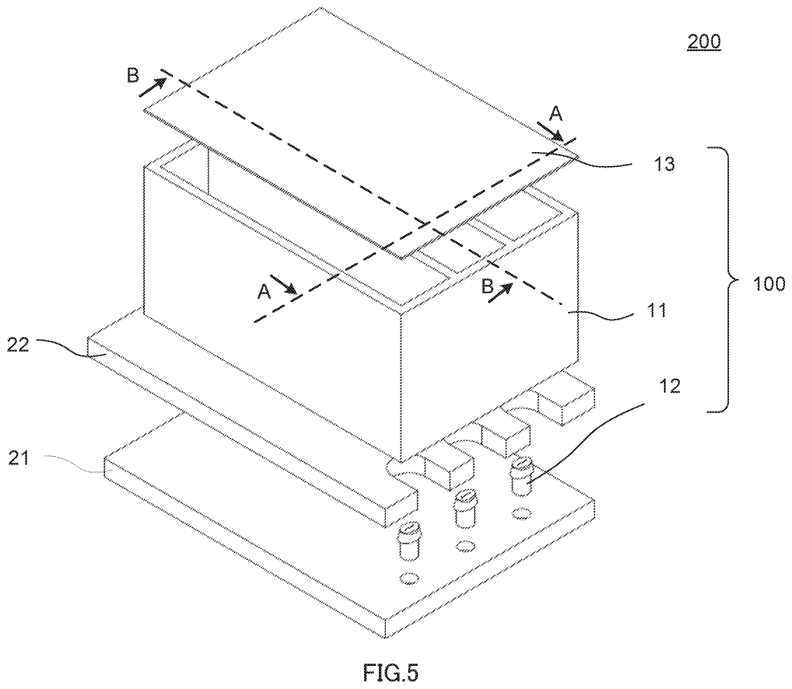

FIG. 5 is an exploded perspective view of fluid handling system 200 of the first embodiment including cartridge 100. Fluid handling system 200 of the present embodiment includes, in addition to cartridge 100, channel chip 21, and detachable spacer 22 disposed between cartridge 100 and channel chip 21. Fluid handling system 200 is used in the state where an end portion on the channel chip 21 (an end portion of cap 12 on the side opposite to the housing part side (hereinafter referred to also as “end portion on the second region side”)) of cap 12 of cartridge 100 is inserted in channel chip 21. Channel chip 21 and a spacer of fluid handling system 200 are described first, and thereafter a fluid handling method using fluid handling system 200 is described.

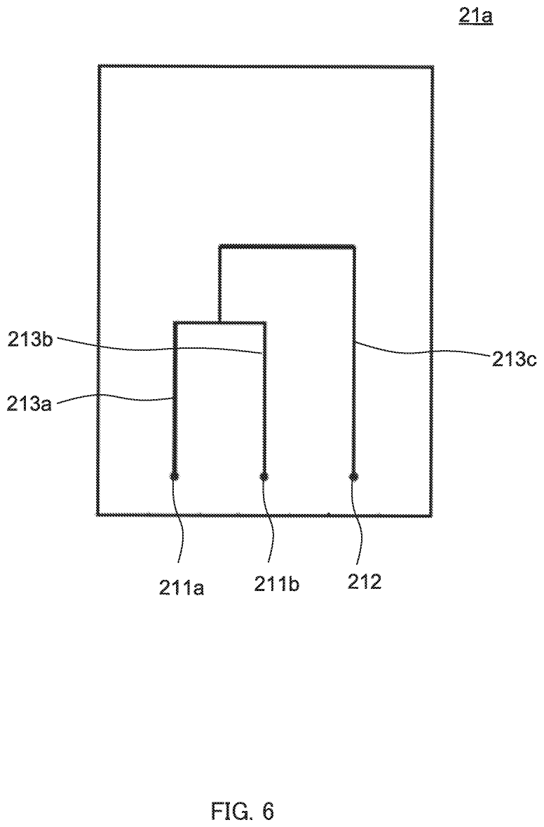

Channel chip 21 of the present embodiment is composed of main body part 21a, and a film (not illustrated) that is bonded to one surface of the main body part so as to cover a groove and a through hole provided in main body part 21a. FIG. 6 is a bottom view of main body part 21a of channel chip 21. Main body part 21a includes first inlet 211a and second inlet 211b for introducing fluid into channel chip 21, and outlet 212 for discharging fluid from channel chip 21. First inlet 211a, second inlet 212b, and outlet 212 are through holes disposed in main body part 21a.

In addition, main body part 21a further includes first groove 213a, second groove 213b and third groove 213c. First groove 213a is a bottomed recess formed in a surface (hereinafter referred to also as “rear surface”) of main body part 21a on which the film (not illustrated) is bonded, and first groove 213a is connected to one end of first inlet 211a. Second groove 213b is a bottomed recess formed in the rear surface of main body part 21a, and one end of second groove 213b is connected to second inlet 211b. Third groove 213c is a bottomed recess formed in the rear surface of main body part 21a, and one end of third groove 213c is connected to first groove 213a and second groove 213b, and, the other end of third groove 213c is connected to outlet 212. Then, in the channel chip 21, the region surrounded by the film and first groove 213a is a first channel, the region surrounded by the film and second groove 213b is a second channel, and the region surrounded by the film and third groove 213c is a third channel for fluid.

In channel chip 21, for example, first fluid (in the present embodiment, a sample) is introduced from first inlet 211a, and second fluid (in the present embodiment, a reagent) is introduced from second inlet 211b. Then, these fluids are caused to flow into the third channel through the first channel and the second channel, and to react in the third channel. Thereafter, the reactant can be moved from outlet 212 to cartridge 100 side through cap 12.

Note that examples of the material of main body part 21a include polyester such as polyethylene terephthalate; polycarbonate; acrylic resin such as polymethylmethacrylate; polyvinyl chloride; polyolefin such as polyethylene, polypropylene, and cycloolefin resin; polyether; polystyrene; silicone resin; and resin materials such as various elastomers. In addition, main body part 21a having the above-described components may be molded by injection molding or the like, for example.

Here, main body part 21a may be or may not be optically transparent. In the case where fluid is observed from the side opposite to the rear surface of main body part 21a and the like, the material is selected such that main body part 21a is optically transparent.

On the other hand, the film (not illustrated) may be a flat film that covers main body part 21a. It suffices that the film is made of a material that is not eroded by the fluid introduced to channel chip 21, and the thickness thereof and the like are appropriately selected. Examples of the material of the film include polyester such as polyethylene terephthalate; polycarbonate; acrylic resin such as polymethylmethacrylate; polyvinyl chloride; polyolefin such as polyethylene, polypropylene, and cycloolefin resin; polyether; polystyrene; silicone resin; and resin materials such as various elastomers.

The material of the film is selected such that the film is optically transparent when observation and/or analysis of fluid is performed from the film side in the state where fluid is housed in the third channel. Note that in the case where fluid is observed from the side opposite to the rear surface of main body part 21a, the case where fluid is not observed, and the like, the film may not be optically transparent.

In addition, main body part 21a and the film may be joined by publicly known methods such as heat fusing and bonding with an adhesive agent.

On the other hand, spacer 22 of the fluid handling system is a member for sufficiently spacing between cartridge 100 and channel chip 21, and maintaining the state where first region 121 of cap 12 of cartridge 100 is housed in pressing region 112a of opening 112 of reservoir 11.

It suffices that spacer 22 is detachably disposed to fluid handling system 200. The shape of spacer 22 is not limited although a comb-shaped member that can be inserted in one direction between cartridge 100 and channel chip 21 is provided in the present embodiment. In addition, in the present embodiment, spacer 22 is disposed in substantially the entire region where cartridge 100 and channel chip 21 opposite each other, spacer 22 may be disposed only in a portion of the region where cartridge 100 and channel chip 21 opposite each other.

In addition, the thickness of spacer 22 is not limited as long as the first region of cap 12 housed in pressing region 112a of opening 112 of reservoir 11 does not move to the housing part 111 side of reservoir 11 due to the own weight of reservoir 11, an external impact and the like, and the thickness of spacer 22 is appropriately selected in accordance with the height of the second region of cap 12 and the like, for example. Note that if the thickness of spacer 22 is excessively large, the end portion of cap 12 on the channel chip 21 side may come out from the inlet and the outlet (first inlet 211a, second inlet 211b, and outlet 212) of channel chip 21. For this reason, it is preferable to set an appropriate thickness in accordance with the height of cap 12 and the like.

The material of spacer 22 is not limited as long as the gap between cartridge 100 and channel chip 21 can be sufficiently maintained, and cartridge 100 and channel chip 21 are not damaged when pulling out spacer 22 and the like. Examples of the material of spacer 22 include polyester such as polyethylene terephthalate; polycarbonate; acrylic resin such as polymethylmethacrylate; polyvinyl chloride; polyolefin such as polyethylene, polypropylene, and cycloolefin resin; polyether; and polystyrene resin materials. In addition, spacer 22 can be molded by injection molding and the like, for example.

Note that fluid handling system 200 may include a supporting part and the like for supporting reservoir 11 such that reservoir 11 does not come out from channel chip 21 and that the position with respect to channel chip 21 is not shifted after spacer 22 is removed from fluid handling system 200 as described later.

### Fluid Handling Method

A fluid handling method using fluid handling system 200 is described below.

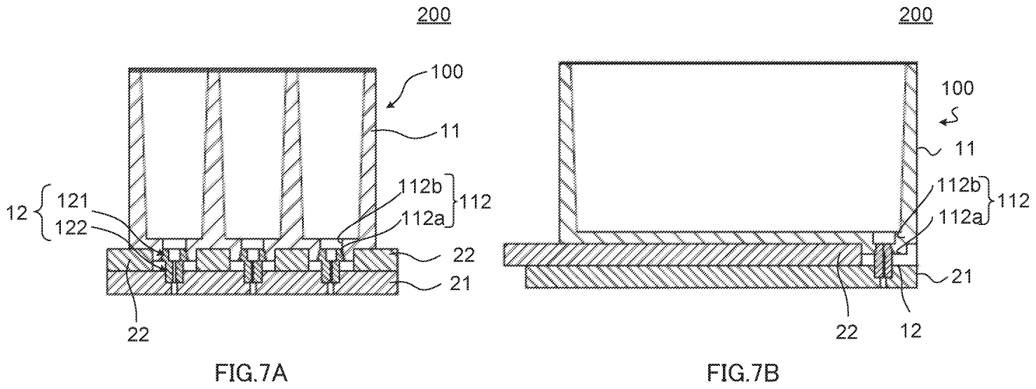

As illustrated in FIGS. 7A and 7B, the fluid handling system of the present embodiment is prepared in the state where cartridge 100, channel chip 21, and spacer 22 are combined. Note that FIG. 7A is a sectional view taken along line A-A of FIG. 5, and FIG. 7B is a sectional view taken along line B-B of FIG. 5.

In cartridge 100 of fluid handling system 200, first region 121 of cap 12 is housed in pressing region 112a of reservoir 11 in the state where first region 121 of cap 12 is pressed in two directions (directions indicated by arrows in FIG. 4A) toward central axis CA along the direction of the minor axis of the rhombus. On the other hand, the end portion of cap 12 on the channel chip 21 side (second region 122 side) is inserted to the inlet and outlet of channel chip 21.

At this time, spacer 22 is disposed between reservoir 11 and channel chip 21 so as to prevent cap 12 from being pushed into the housing part 111 side of reservoir 11 by the own weight of reservoir 11.

Then, housing part 111 of reservoir 11 of cartridge 100 set to the closed state is filled with the desired fluid, and housing part 111 is closed with lid 13. When channel chip 21 is used, one of three housing parts 111 is filled with sample, another one is filled with reagent, and the other one is used for fluid collection, i.e., set to an empty state. Note that depending on the type of channel chip 21, all housing parts may be filled with fluid. Alternatively, reservoir 11 may be filled with various types of fluid (such as a reagent and a sample) in advance.

In addition, the type of the fluid to be housed in cartridge 100 (housing part 111 of reservoir 11) is not limited as long as the fluid can pass through through hole 120 of cap 12. The fluid may contain a single component, or a plurality of components. In addition, the fluid is not limited to liquid, and may be a solvent in which solid components are dispersed, for example. In addition, the fluid may be a solvent in which droplets (liquid droplets) incompatible with the solvent or the like are dispersed and the like.

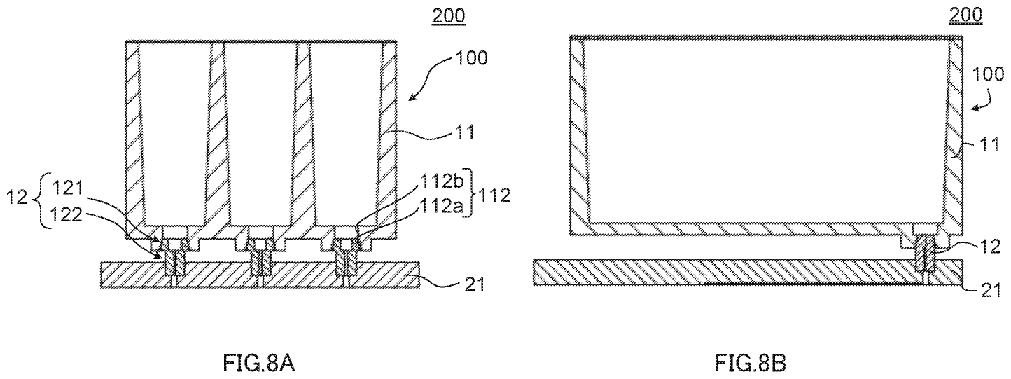

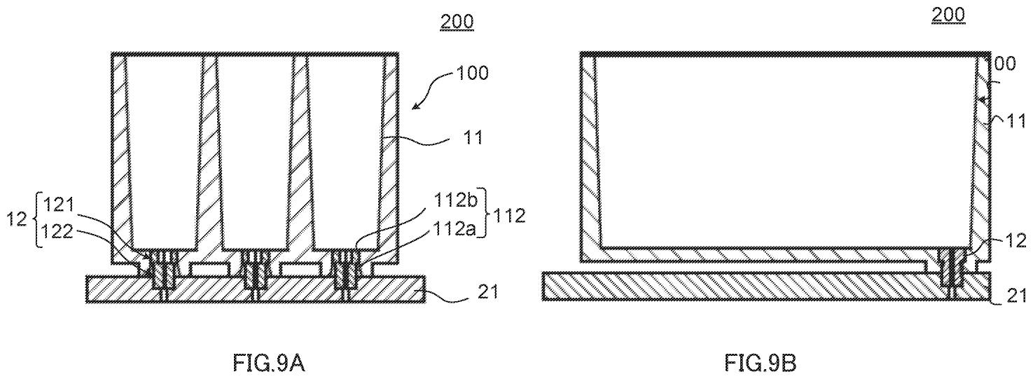

Then, in fluid handling system 200, to discharge fluid from reservoir 11 to channel chip 21 side, spacer 22 is removed as illustrated in FIGS. 8A and 8B. Then, as illustrated in FIGS. 9A and 9B, the first region of cap 12 is pushed to the open region 112b side of opening 112. Note that FIGS. 8A and 9A are sectional views taken along line A-A of FIG. 5, and FIGS. 8B and 9B are sectional views taken along line B-B of FIG. 5. In the drawings, the components same as those of FIGS. 7A and 7B are denoted by the same numbers. Note that illustrated in FIGS. 8A and 8B state, first region 121 of cap 12 may be pushed to the open region 112b side as illustrated in FIGS. 9A and 9B by utilizing the own weight of reservoir 11, or by the user pushing reservoir 11 downward in the gravity direction. Alternatively, channel chip 21 and reservoir 11 may be sandwiched using various devices to push first region 121 of cap 12 to the open region 112b side of opening 112. Through this operation, through hole 120 of first region 121 and second region 122 of cap 12 is opened, and fluid can pass through the inside of through hole 120 of cap 12.

Note that as necessary, a pressure may be applied to housing part 111 in which the fluid is housed, or suction from a specific housing part 111 may be performed to facilitate the flow of the fluid in through hole 120 of cap 12. In addition, a flow of the fluid may be caused by capillarity.

### 2-2. Second Embodiment

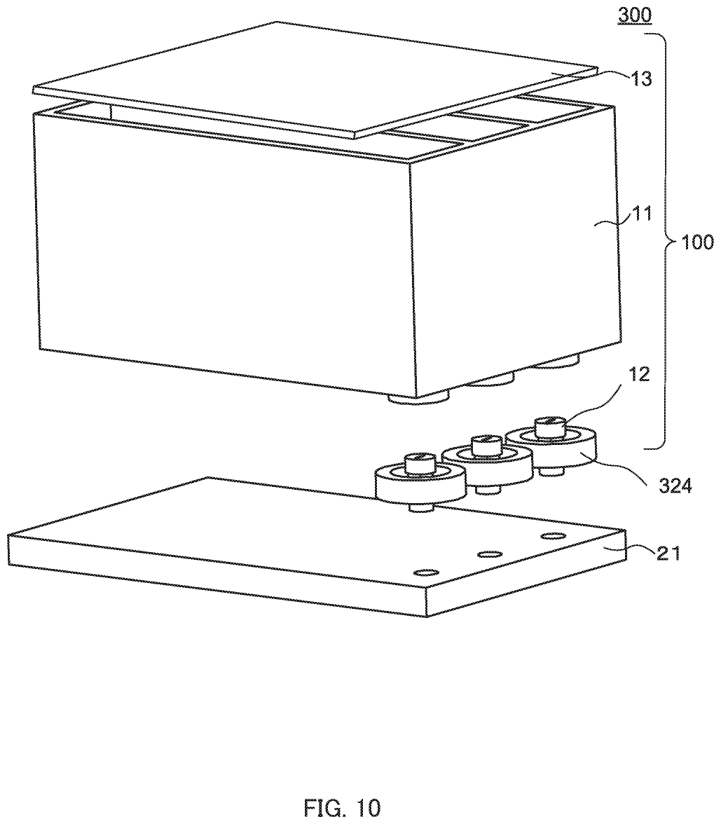

FIG. 10 is an exploded perspective view of fluid handling system 300 of the second embodiment including cartridge 100. Note that the same components as those of fluid handling system 200 of the first embodiment are denoted with the same reference numerals, and detailed description thereof is omitted.

Fluid handling system 300 of the present embodiment includes, in addition to cartridge 100, channel chip 21 and auxiliary member 324. While auxiliary member 324 and cap 12 of cartridge 100 are integral with each other in FIG. 10, they are detachable, and are normally separately formed. In addition, in fluid handling system 300, a spacer (not illustrated) similar to spacer 22 of the first embodiment may be further provided, or auxiliary member 324 may serve a function similar to the function of the spacer. Now auxiliary member 324 is elaborated below.

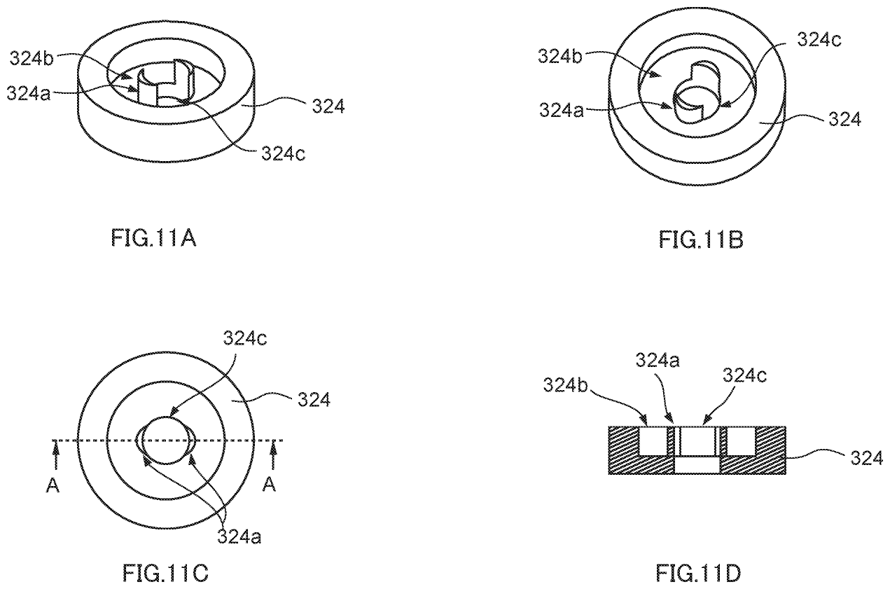

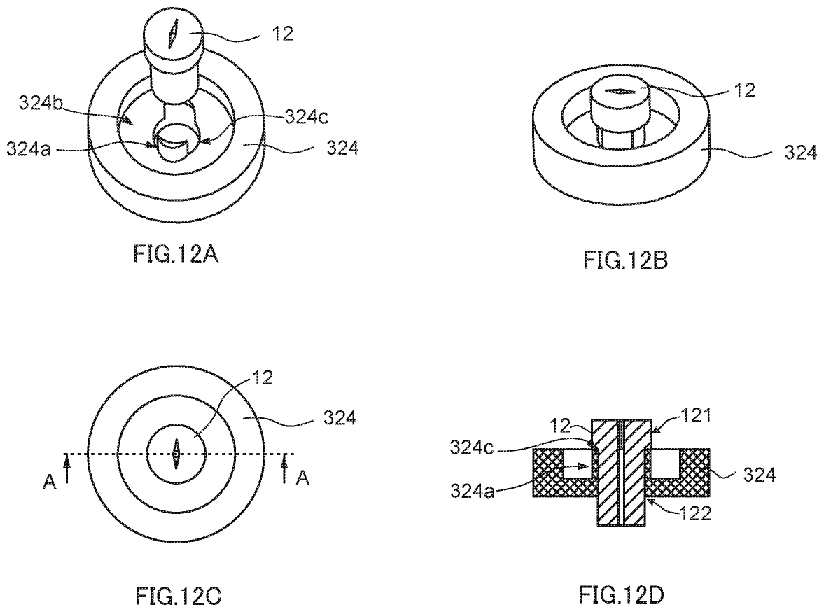

Auxiliary member 324 of the present embodiment is a member for supporting second region 122 of cap 12. FIG. 11A is a perspective view of auxiliary member 324, and FIG. 11B is a perspective view of auxiliary member 324 as viewed from another angle. Further, FIG. 11C is a plan view of auxiliary member 324, and FIG. 11D is a sectional view taken along line A-A of FIG. 11C. In addition, FIG. 12A is a perspective view of a state before cap 12 is fitted to auxiliary member 324, and FIG. 12B is a perspective view of a state after cap 12 is fitted to auxiliary member 324. Further, FIG. 12C is a plan view of a state after cap 12 is fitted to auxiliary member 324, and FIG. 12D is a sectional view taken along line A-A of FIG. 12C.

As illustrated in FIGS. 11A and 11B, auxiliary member 324 of the present embodiment has a substantially columnar external shape. The diameter of auxiliary member 324 is not limited as long as auxiliary member 324 does not interfere with other members. Auxiliary member 324 includes through hole 324c that is approximately parallel to the central axis (not illustrated) of auxiliary member 324, and second region 122 of cap 12 is fitted to through hole 324c as illustrated in FIG. 12D. The diameter of through hole 324c is approximately the same as the outer diameter of second region 122 of cap 12.

Auxiliary member 324 includes at the outer edge of through hole 324c, two supporting parts 324a facing each other as illustrated in FIG. 11C, etc. Supporting part 324a is a structure for supporting the side surface of second region 122 of cap 12 from the both sides. In the present embodiment, each supporting part 324a has a columnar structure that surrounds approximately ¼ of the outer peripheral surface of second region 122 of cap 12 having a columnar shape. In addition, each supporting part 324a has a crescent-shape in plan view. With such a shape of each supporting part 324a, the shape of the combination of second region 122 of cap 12 and two supporting parts 324a is approximately the same as the shape (elliptical columnar shape) of the opening of pressing region 112a of opening 112 of reservoir 11. Thus, when second region 122 of cap 12 is moved into pressing region 112a of opening 112 of reservoir 11, supporting part 324a can also be moved into pressing region 112a. That is, with supporting part 324a, cap 12 can be moved while supporting second region 122, and thus deformation of second region 122 due to movement can be suppressed.

Note that the shape of supporting part 324a of auxiliary member 324 is appropriately selected in accordance with the shape of the opening of pressing region 112a of opening 112 of reservoir 11, and is not limited to the above-described shape. In addition, while the thickness is constant from the tip end side to the bottom end side of supporting part 324a in the present embodiment, the thickness may be changed in accordance with the shape of the opening of pressing region 112a of reservoir 11.

In addition, the height of supporting part 324a is appropriately selected in accordance with the height of second region 122 of cap 12. In the present embodiment, the sum of the height of auxiliary member 324 (the height of supporting part 324a and the depth of through hole 324c) and the depth of the inlet (or outlet) of channel chip 21 is set to a value that is approximately equal to the height of second region 122 of cap 12.

In addition, auxiliary member 324 of the present embodiment includes annular recess 324b around supporting part 324a. In the present embodiment, a portion of the exterior wall of opening 112 of reservoir 11 protrudes in an annular shape from the bottom surface side of reservoir 11 toward the channel chip 21 side. With auxiliary member 324 including annular recess 324b, a portion of the exterior wall of opening 112 of reservoir 11 can be fit into recess 324b as necessary. As a result, when moving cap 12 and auxiliary member 324 to the housing part 111 side of reservoir 11, positional displacement or the like is not easily caused, and the blockage of through hole 120 of cap 12 is suppressed.

The width and depth of recess 324b are appropriately selected in accordance with the shape of opening 112 of reservoir 11. In the present embodiment, the width and depth of recess 324b are set such that the exterior wall (wall surface and bottom surface) and opening 112 of reservoir 11 make contact with the wall surface and bottom surface of the recess 324b when second region 122 of cap 12 and supporting part 324a of auxiliary member 324 are housed in pressing region 112a opening 112 of reservoir 11.

### Fluid Handling Method

A fluid handling method using fluid handling system 300 is described below.

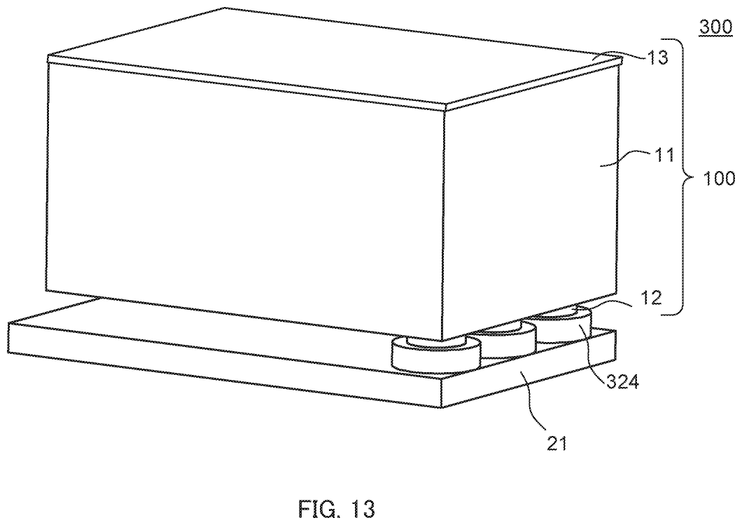

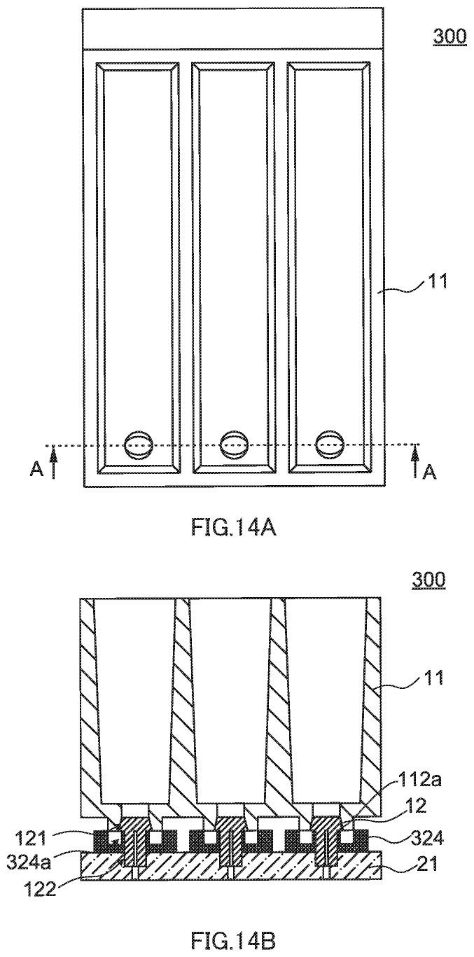

In fluid handling system 300 of the present embodiment, first, cartridge 100, channel chip 21, and auxiliary member 324 are combined and installed as illustrated in FIG. 13. FIG. 14A is a plan view of fluid handling system 300 (a state where lid 13 is removed for the sake of illustration convenience), and FIG. 14B is a sectional view taken along line A-A of FIG. 14A.

To be more specific, first region 121 of cap 12 is housed to pressing region 112a of reservoir 11 in the state where first region 121 of cap 12 is pressed toward central axis CA along the direction of the minor axis of the rhombus from two directions (the arrow directions in FIG. 4A).

In addition, after second region 122 of cap 12 is fitted to supporting part 324a of auxiliary member 324, the end portion of cap 12 on the channel chip 21 side is inserted to the inlet or outlet of channel chip 21.

Here, a spacer (not illustrated) may be disposed between reservoir 11 and channel chip 21 as necessary so as to prevent cap 12 from being pushed into the housing part 111 side of reservoir 11 by the own weight of reservoir 11. Then, as in the first embodiment, housing part 111 of reservoir 11 of cartridge 100 set to the closed state is filled with the desired fluid, and housing part 111 is closed with lid 13.

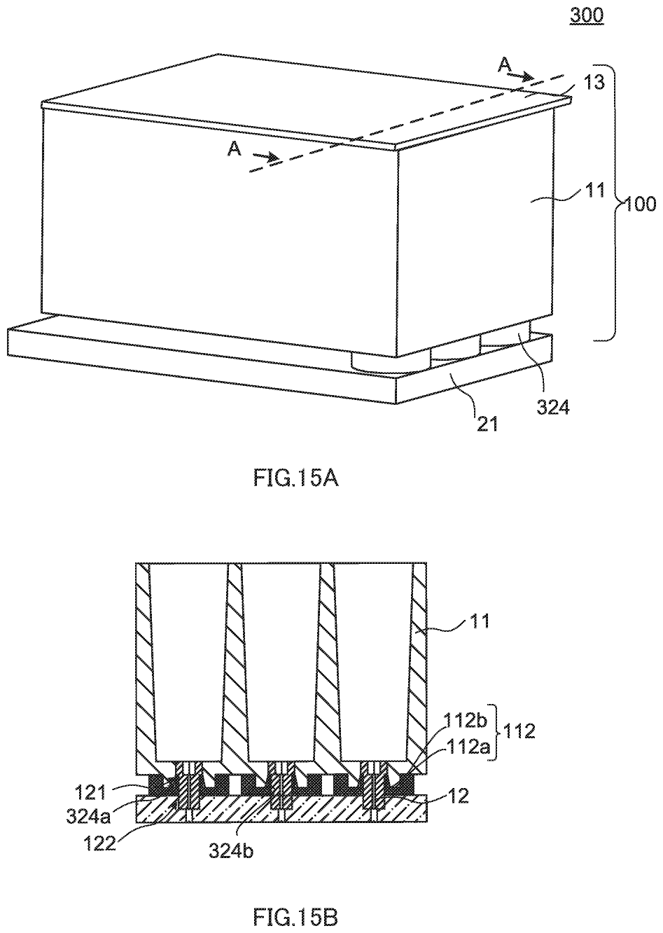

When discharging fluid from reservoir 11 to the channel chip 21 side, cap 12 and auxiliary member 324 are pushed to the reservoir 11 side, as illustrated in FIGS. 15A and 15B. To be more specific, cap 12 is pushed such that first region 121 of cap 12 is housed in open region 112b of opening 112 of reservoir 11. At this time, auxiliary member 324 is also moved together with cap 12, and second region 122 of cap 12 and supporting part 324a of auxiliary member 324 are housed in pressing region 112a of opening 112 of reservoir 11. Simultaneously, a portion of the exterior wall of opening 112 of reservoir 11 is housed in recess 324b of auxiliary member 324. FIG. 15B is a perspective view a sectional view taken along line A-A of FIG. 15A.

Here, as illustrated in FIG. 15B, as the way of pushing cap 12 and auxiliary member 324 to the reservoir 11 side, the own weight of reservoir 11 may be utilized or the user may push reservoir 11 downward in the gravity direction. Channel chip 21 and reservoir 11 may be sandwiched using various devices to push cap 12 and auxiliary member 324 to the reservoir 11 side. Through this operation, through hole 120 of first region 121 and second region 122 of cap 12 is opened, and fluid can pass through the inside of through hole 120 of cap 12.

Note that as necessary, a pressure may be applied to housing part 111 in which the fluid is housed, or suction from a specific housing part 111 may be performed to facilitate the flow of the fluid in through hole 120 of cap 12. In addition, a flow of the fluid may be caused by capillarity.

### 2-3. Third Embodiment

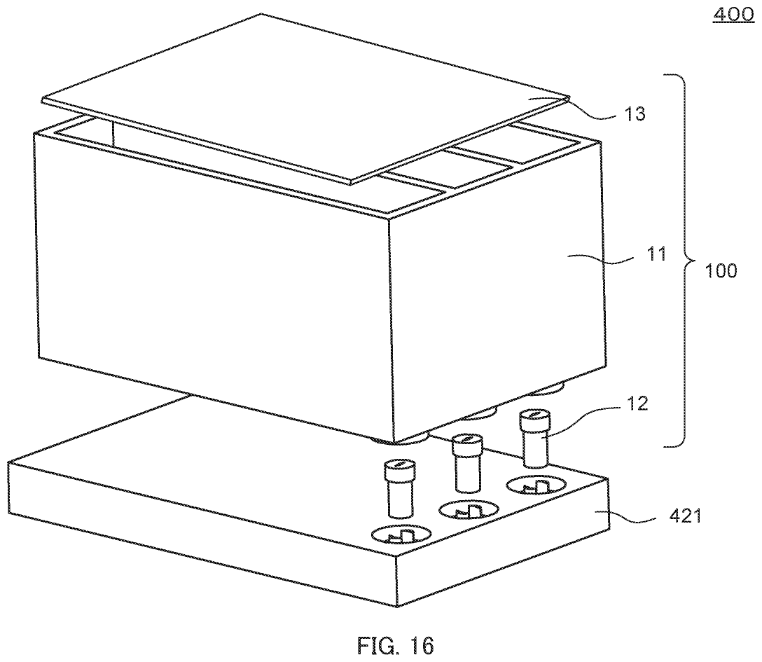

FIG. 16 is an exploded perspective view of fluid handling system 400 of a third embodiment including cartridge 100. Note that the same components as those of fluid handling system 200 of the first embodiment are denoted with the same reference numerals, and detailed description thereof is omitted.

Fluid handling system 400 of the present embodiment includes channel chip 421, in addition to cartridge 100. Note that the fluid handling system 400 may or may not include a spacer (not illustrated) similar to spacer 22 of the first embodiment.

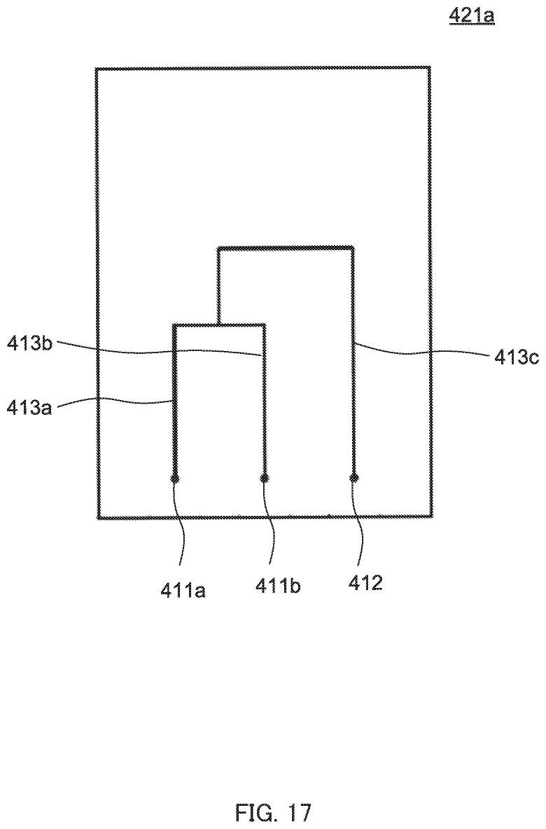

Channel chip 421 of the present embodiment is elaborated below. Channel chip 421 of the present embodiment includes main body part 421a, and a film (not illustrated) that is bonded to one surface of main body part 421a so as to cover a groove provided in main body part 421a. FIG. 17 is a bottom view of main body part 421a of channel chip 421. As with channel chip 21 of the first embodiment, main body part 421a includes first inlet 411a and second inlet 411b for introducing fluid into channel chip 421, and outlet 412 for discharging fluid from channel chip 421. First inlet 411a, second inlet 411b, and outlet 412 are through holes disposed in main body part 421a.

In addition, main body part 421a includes first groove 413a, second groove 413b and third groove 413c. First groove 413a is a bottomed recess that is formed in the surface (hereinafter referred to also as “rear surface”) of main body part 421a on the side on which the film (not illustrated) is bonded, and one end of first groove 413a is connected to first inlet 411a. Second groove 413b is a bottomed recess formed on the rear surface side of main body part 421a, and one end of second groove 413b is connected to second inlet 411b. Third groove 413c is a bottomed recess formed on the rear surface side of main body part 421a. One end of third groove 413c is connected to first groove 413a and second groove 413b, and the other end of third groove 413c is connected to outlet 412. In channel chip 421, the region surrounded by the film and first groove 413a is the first channel, the region surrounded by the film and second groove 413b is the second channel, and the region surrounded by the film and third groove 413c is the third channel for fluid. The method of using channel chip 421 is the same as that of channel chip 21 of the first embodiment.

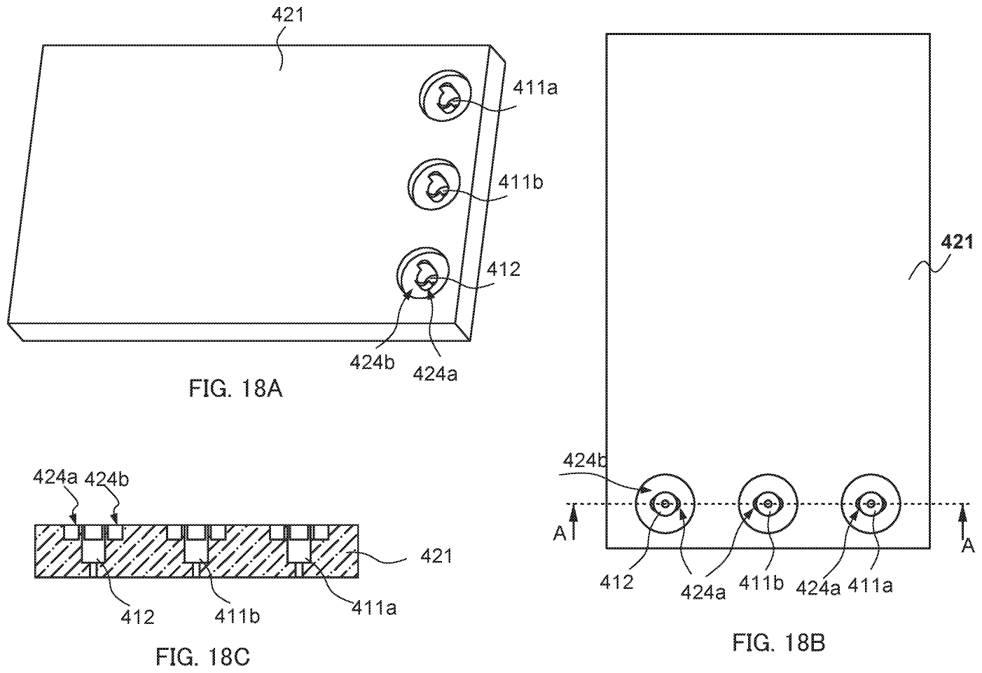

FIG. 18A is a perspective view of a surface of main body part 421a on the side opposite to the surface in which first groove 413a and the like are disposed, and FIG. 18B is a plan view. FIG. 18C is a sectional view taken along line A-A of FIG. 18B. As illustrated in FIG. 18A, in channel chip 421 of the present embodiment, two supporting parts 424a facing each other are provided at the outer edges of first inlet 411a, second inlet 411b, and outlet 412.

Supporting part 424a is a structure for supporting the side surface of second region 122 of cap 12 from the both sides. In the present embodiment, supporting part 424a is a columnar structure that surrounds approximately ¼ of the outer peripheral surface of second region 122 of cap 12 having a columnar shape. In addition, each supporting part 424a has a crescent-shape in plan view. With each supporting part 424a having such a shape, the shape of combination of second region 122 of cap 12 and two supporting parts 424a is approximately the same as the shape (elliptical columnar shape) of the opening of pressing region 112a of opening 112 of reservoir 11. Accordingly, when moving second region 122 of cap 12 into pressing region 112a of opening 112 of reservoir 11, supporting part 424a can be moved into pressing region 112a. That is, with supporting part 424a, cap 12 can be moved while supporting second region 122, and deformation of second region 122 due to movement can be suppressed.

Note that the shape of supporting part 424a is appropriately selected in accordance with the shape of the opening of pressing region 112a of opening 112 of reservoir 11, and is not limited to the above-described shape. In addition, while the thickness of supporting part 424a is constant from the end side to the bottom end side in the present embodiment, the thickness may change in accordance with the shape of the opening of pressing region 112a of reservoir 11.

In addition, the height of supporting part 424a is appropriately selected in accordance with the height of second region 122 of cap 12. In the present embodiment, the sum of each depth of the inlet and the outlet (first inlet 411a, second inlet 411b, and outlet 412) and the height of supporting part 424a is set to a value that is approximately equal to the height of second region 122 of cap 12.

In addition, channel chip 421 of the present embodiment includes annular recess 424b around supporting part 424a. In the present embodiment, a portion of the exterior wall of opening 112 of reservoir 11 protrudes in an annular shape from the bottom surface side of reservoir 11 toward the channel chip 421 side. With channel chip 421 including annular recess 424b, a portion of the exterior wall of opening 112 of reservoir 11 can be fitted to the inside of recess 424b as necessary. As a result, when moving cap 12 and channel chip 421 to the housing part 111 side of reservoir 11, positional displacement and the like are not easily caused, and in turn, the blockage of through hole 120 of cap 12 can be suppressed.

The width and depth of recess 424b are appropriately selected in accordance with the shape of opening 112 of reservoir 11. In the present embodiment, the width and depth of recess 424b are set such that when the second region 122 of cap 12 and supporting part 424a of channel chip 421 are housed in pressing region 112a opening 112 of reservoir 11, the exterior wall (wall surface and bottom surface) of opening 112 of reservoir 11 makes contact with the wall surface and bottom surface of recess 424b.

### Fluid Handling Method

A fluid handling method using fluid handling system 400 is described below.

In fluid handling system 400 of the present embodiment, first, cartridge 100 and channel chip 421 are combined and installed. To be more specific, first region 121 of cap 12 is housed to pressing region 112a of reservoir 11 in the state where first region 121 of cap 12 is pressed toward central axis CA along the direction of the minor axis of the rhombus from two directions (the arrow directions in FIG. 4A).

In addition, the side surface of second region 122 of cap 12 is sandwiched by supporting part 424a of channel chip 421, and the end portion of cap 421 on the second region 122 side is inserted to first inlet 411a, second inlet 411b, and outlet 412 of channel chip 421.

Here, a spacer (not illustrated) is disposed between reservoir 11 and channel chip 421 as necessary so as to prevent cap 12 from being pushed into the housing part 111 side of reservoir 11 by the own weight of reservoir 11. Then, as in the first embodiment, housing part 111 of reservoir 11 of cartridge 100 set to the closed state is filled with the desired fluid, and housing part 111 is closed with lid 13.

Then, when discharging fluid from reservoir 11 to the channel chip 421 side, cap 12 and channel chip 421 are pushed to the reservoir 11 side. To be more specific, the cap is pushed such that first region 121 of cap 12 is housed in open region 112b of opening 112. At this time, channel chip 421 is also moved together with cap 12, and second region 122 of cap 12 and supporting part 424a of channel chip 421 are housed in pressing region 112a of opening 112 of reservoir 11. Simultaneously, a portion of the exterior wall of opening 112 of reservoir 11 is housed in recess 424b of channel chip 421.

As the way for pushing cap 12 and channel chip 421 to the reservoir 11 side, the own weight of reservoir 11 may be utilized, or the user may push reservoir 11 downward in the gravity direction. Alternatively, channel chip 421 and reservoir 11 may be sandwiched using various devices. Through this operation, through hole 120 of first region 121 and second region 122 of cap 12 is opened, and fluid can pass through the inside of through hole 120 of cap 12.

Note that as necessary, a pressure may be applied to housing part 111 in which the fluid is housed, or suction from a specific housing part 111 may be performed to facilitate the flow of the fluid in through hole 120 of cap 12. In addition, a flow of the fluid may be caused by capillarity.

### Effect

With the cartridge according to the embodiment, the fluid housed in the housing part can be discharged by only pushing the cap into the cartridge after one end of the cap (the end portion of the cap on the second region side) is inserted to the inlet of the desired channel chip and the like. In addition, when a plurality types of liquid are housed in housing part, they can be simultaneously discharged. Accordingly, without using a large-scale device, the desired fluid can be supplied to the chip and the like, and the cartridge is extremely useful in terms of cost, and operation efficiency. In addition, when the cap is pushed into the cartridge after one end of the cap (the end portion of the cap on the second region side) is inserted to the inlet of the desired channel chip and the like, the inner pressure of the housing part of the reservoir is increased. Therefore, with the increased inner pressure, the fluid housed in the housing part is easily discharged.

In addition, with the fluid handling system according to the first embodiment, various types of fluid can be supplied into the channel chip by only removing the spacer and pushing the cap into the reservoir. In addition, also with the fluid handling system of the second embodiment and the fluid handling system of the third embodiment, various types of fluid can be supplied into the channel chip by only pushing the cap to the cartridge side.

In addition, with the fluid handling system of the second embodiment and the third embodiment, the cap can be moved to the reservoir side in the state where the second region of the cap is protected by the supporting part. Accordingly, when moving the cap, bending and folding of the cap can be suppressed, and the fluid can be reliably moved to the channel chip side. Further, in the fluid handling systems, the recess of the channel chip and the auxiliary member and a portion of the exterior wall of the opening of the reservoir are fitted to each other when moving the cap, and thus they cause less positional displacement and the like. Accordingly, the fluid can be more reliably moved to the channel chip side.

Advantageously, in the second embodiment, an auxiliary member can be used in place of a spacer, and further, the spacer is not required to be removed.

Further, in the fluid handling system of each embodiment, the fluid can be collected to the reservoir and the like, and thus inspection and analysis of various types of fluid can be efficiently performed.

### Modification

In the cartridge described above, the open region of the opening of the reservoir is disposed on the housing part side of the reservoir relative to the pressing region of the opening. Note that in the opening of the reservoir, the pressing region may be disposed on the reservoir housing part side relative to the open region. In this case, by pulling the cap from the housing part side toward the outside so as to move the first housing part housed in the pressing region into to the open region, the cartridge can be set to the open state from the closed state.

While the reservoir includes the housing part separately from the opening including the pressing region and the open region in the cartridge described above, the housing part may serve also as the open region. In this case, when setting the cartridge to the closed state, the first region of the cap is housed in the pressing region. On the other hand, when setting the cartridge to the open state, the first region of the cap is pushed into the housing part. With this configuration, the pressing of the pressing region to the first region is released, and fluid can pass through the inside of the through hole of the cap.

While the shape of the opening of the pressing region of the reservoir is an elliptical shape in the cartridge described above, shapes other than ellipse may be adopted.

In addition, while the reservoir has a substantially cuboid shape in the cartridge described above, the shape of the reservoir may have a columnar shape, a bag-shape or the like, for example. Further, the position of the opening is not limited to the bottom of the reservoir, and may be disposed on the side on the bottom side of the reservoir, for example.

In addition, while the cap includes two concentric columns having different diameters are coupled to each other in the cartridge described above, the shape of the cap is not limited to this shape, and, for example, may have a structure of a column having a uniform cross-sectional area from the first region to the second region (note that, in this case, the opening diameter of the through hole of the first region is smaller than the opening diameter of the through hole of the second region), or a structure of a cone shape whose cross-sectional area change continuously (successively) changes. In addition, the cap may have a shape in which two rectangular prisms with different widths are provided in series and the like, for example.

In addition, the cartridge may include a stopper or the like for preventing movement of the first region of the cap to the housing part side from the open region the opening of the reservoir after the cartridge is set to the open state in a part on the second region side of the cap, or in the reservoir.

Further, while the cartridge is combined with a specific channel chip, the chip that is combined with the cartridge is not limited, and may be a microchannel chip, for example. It can be used also for supplying fluid to various devices, various chips and the like other than those described above.

This application claims priority based on Patent Application No. 2018-014839, filed on Jan. 31, 2018. Everything described in the specification and drawings of the application is incorporated herein by reference.

### INDUSTRIAL APPLICABILITY

The cartridge and the fluid handling system of the present invention can be applied to the inspection and analysis of various fluids, for example.

### REFERENCE SIGNS LIST

11 Reservoir
12 Cap
13 Lid
21, 421 Channel chip
21a, 421a Main body part
22 Spacer
100 Cartridge
111 Housing part
112 Opening
112a Pressing region
112b Open region
120 Through hole
121 First region
122 Second region
200, 300, 400 Fluid handling system
211a, 411a First inlet
211b, 411b Second inlet
212, 412 Outlet
213a, 413a First groove
213b, 413b Second groove
213c, 413c Third groove
324 Auxiliary member
324a, 424a Supporting part
324b, 424b Recess
324c Through hole

1. A cartridge comprising:
a reservoir including a housing part configured to house fluid and an opening disposed in a portion of the housing part and configured to communicate between the housing part and outside; and
a cap configured to be fitted to the opening of the reservoir and composed of an elastomer having flexibility, the cap having a columnar shape and including a through hole that is substantially parallel to a central axis of the cap,
wherein the opening of the reservoir includes a pressing region configured to press a portion of the cap toward the central axis, and an open region whose pressing force toward the central axis of the cap is smaller than that of the pressing region,
wherein the cap includes a first region configured to be pressed toward the central axis when located in the pressing region of the reservoir,
wherein when the first region is located in the pressing region and an exterior wall of the opening presses the first region toward the central axis such that the through hole of the first region is closed, a closed state in which fluid in the housing part is not discharged to the outside through the through hole is set, and
wherein when the first region is moved to the open region and the through hole of the first region is opened, an open state in which the fluid is allowed to be discharged to the outside from the housing part through the through hole is set.

2. The cartridge according to claim 1,
wherein the first region is disposed at a first end portion of the cap, the first end portion being located on a side facing the housing part; and
wherein the through hole in the first region has a slit shape.

3. The cartridge according to claim 1,
wherein the open region of the reservoir is disposed at a position closer to the housing part than the pressing region; and
an opening cross-sectional area of the open region is greater than an opening cross-sectional area of the pressing region.

4. The cartridge according to claim 1,
wherein a cross-sectional shape of the first region of the cap in a direction perpendicular to the central axis is a circular shape; and
wherein an opening shape of the pressing region of the reservoir is an elliptical shape.

5. The cartridge according to claim 1,
wherein the cap includes a second region whose cross-sectional area in a cross-section perpendicular to the central axis of the cap is smaller than that of the first region; and
wherein the first region is disposed at a position closer to the housing part of the reservoir than the second region.

6. A fluid handling system comprising:
the cartridge according to claim 1; and
a channel chip including an inlet to which a second end portion of the cap is inserted, the second end portion being located on a side opposite to the side facing the housing part,
wherein when the first region of the cap of the cartridge is moved from a pressing region side into the open region of the reservoir, the fluid is discharged from the housing part toward the channel chip through the through hole of the cap.

7. The fluid handling system according to claim 6, further comprising a spacer disposed between the cartridge and the channel chip.

8. The fluid handling system according to claim 6, further comprising two supporting parts facing each other,
wherein a side surface of the second region of the cap is supported by the supporting part, and
wherein when the first region of the cap is moved from the pressing region side into the open region of the reservoir, the second region of the cap and the supporting part are housed in the pressing region of the reservoir.

9. The fluid handling system according to claim 8, further comprising an auxiliary member disposed between the cartridge and the channel chip,
wherein the auxiliary member includes the supporting part.

10. The fluid handling system according to claim 9,
wherein a portion of the exterior wall of the opening of the reservoir protrudes from a bottom surface side of the reservoir toward the channel chip; and
wherein the auxiliary member includes, at a position around the supporting part, a recess configured to fit with the portion of the exterior wall of the opening of the reservoir.

11. The fluid handling system according to claim 8, wherein the channel chip includes the supporting part.

12. The fluid handling system according to claim 11,
wherein a portion of the exterior wall of the opening of the reservoir protrudes from a bottom surface side of the reservoir toward the channel chip; and
wherein the channel chip includes, at a position around the supporting part, a recess configured to fit with the portion of the exterior wall of the opening of the reservoir.
